(19) United States
(12) Patent Application Publication
(10) Pub. No.: US 2009/0122001 A1
(43) Pub. Date: May 14, 2009

(54) Method and apparatus for image display with backlight illumination

(75) Inventors: Yuk Lung Cheung, Hong Kong (CN); Kwan Wah Ng, Hong Kong (CN); Chen Jung Tsai, Judung (TW); Huajun Peng, Hong Kong (CN); Chun Kit Hung, Hong Kong (CN)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Co., Ltd., New Territories (CN)

(21) Appl. No.: 11/979,935

(22) Filed: Nov. 9, 2007

(51) Int. Cl. G09G 3/36

(52) U.S. Cl. 345/102

(57) ABSTRACT

An LCD display apparatus arranged to display image on an image display surface at an image frame rate of M image frames per second, the apparatus including a backlight arrangement comprising an LED backlight device for providing backlight illumination to said image display surface and a backlight controller for controlling the generation of backlight and intensity distribution of backlight illumination on said image display surface; wherein the backlight controller comprises a processor configured to generate a set of backlight illumination data with reference to the intensity distribution characteristics of the image content of said image frame according to a predetermined relationship, wherein said set of backlight illumination data contains information on the required intensity distribution of backlight on said image display surface for said image frame; and to generate a plurality of backlight illumination frames for each said image frame during the duration of said image frame based on said set of backlight illumination data; wherein the intensity aggregate of said plurality of backlight illumination frames generated during the duration of said image frame is equivalent to the required intensity distribution of backlight on said image display surface for said image frame.

### FIELD OF THE INVENTION

The present invention relates to method and apparatus for image display, and more particularly, to method and apparatus for image display with a backlight arrangement. More specifically, this invention relates to an LCD display with an LED backlight arrangement.

### BACKGROUND OF THE INVENTION

Many image display devices comprise an image display surface, for example, an LCD display surface, with backlight illumination. In a conventional LCD display panel, a backlight of a uniform intensity is typically supplied behind the LCD panel and the liquid crystal cells on the LCD surface control the pixel brightness by changing transparencies. In general, the pixel brightness as perceived by a viewer on an LCD display is the product of backlight luminous intensity and liquid crystal cell transparency. More recently, there has been an increased use of dynamic schemes for control of backlight illumination to improve the contrast of a backlit LCD display. An example of such an active dynamic control backlight unit for an LCD display is discussed in U.S. Ser. No. 11/707,517 by the applicant, which is incorporated herein by reference.

Typically, dynamic backlight illumination is achieved by processing an image signal to be displayed, and then to generate backlight illumination with an intensity commensurate with the intensity of the image to be displayed by PWM (pulse width modulated) control of the backlight sources. However, such an arrangement is relatively expensive and the data transfer rate is slow. The use of PWM schemes for backlight intensity control is even less desirable as the number of pixels increases for ever high resolution. Therefore, it is desirable if an improved scheme of dynamic backlight illumination control can be provided.

### SUMMARY OF THE INVENTION

Broadly speaking, the present invention has described an LCD display apparatus arranged to display image on an image display surface at an image frame rate of M image frames per second, the apparatus including a backlight arrangement comprising an LED backlight device for providing backlight illumination to said image display surface and a backlight controller for controlling the generation of backlight and intensity distribution of backlight illumination on said image display surface; wherein the backlight controller comprises a processor configured to generate a set of backlight illumination data with reference to the intensity distribution characteristics of the image content of said image frame according to a predetermined relationship, wherein said set of backlight illumination data contains information on the required intensity distribution of backlight on said image display surface for said image frame; and to generate a plurality of backlight illumination frames for each said image frame during the duration of said image frame based on said set of backlight illumination data; wherein the intensity aggregate of said plurality of backlight illumination frames generated during the duration of said image frame is equivalent to the required intensity distribution of backlight on said image display surface for said image.

The preferred invention has described a method of generating LED backlight illumination for an image display surface of an LCD display device, wherein said LCD display device is arranged to generate video images at an image frame rate of M image frames per second, and the backlight illumination has a pattern of intensity having a distribution of intensity correlating to the intensity distribution of an image frame to be or being display on said display surface, the method comprising the steps of evaluating intensity distribution characteristics of said image frame on said image display surface, determining a pattern of required backlight intensity distribution in relation to said intensity distribution characteristics of said image frame according to a predetermined relationship, and generating a plurality of frames of backlight illumination for each said image frame, wherein the intensity aggregate of said plurality of frames of backlight illumination generated during the during of said image frame is equivalent to said pattern of required backlight intensity distribution.

By generating a plurality of backlight illumination frames for each image frame to produce an aggregate of backlight illumination level for an image frame, the need of customised hardware such as PWM drivers, can be obviated.

### BRIEF DESCRIPTION OF THE DRAWINGS

Preferred embodiments of the present invention will be explained in further detail below by way of examples and with reference to the accompanying drawings, in which:

FIG. 1 is a schematic diagram showing an arrangement of an LCD display with a backlight arrangement of this invention,

FIG. 2 is a block diagram showing functional blocks of the image display apparatus of this invention,

FIG. 3 is a schematic diagram showing exemplary physical layout of individual backlight sources of the backlight device of this invention,

FIG. 4 is an exemplary schematic circuit representation showing a schematic circuitry of the backlighting arrangement of this invention, and

FIG. 5 shows schematically an exemplary operation of a plurality of backlight illumination frames to form an aggregate grey level of an image frame of this invention,

FIG. 6 shows schematically a second exemplary operation of a plurality of backlight illumination frames to form an aggregate grey level of an image frame of this invention,

FIG. 7 illustrates an exemplary timing relationship between an image frame and the plurality of backlight frames corresponding to the image frame, and

FIG. 8 illustrates a second exemplary timing relationship between an image frame and the plurality of backlight frames corresponding to the image frame.

### DETAILED DESCRIPTION OF THE PREFERRED EMBODIMENTS

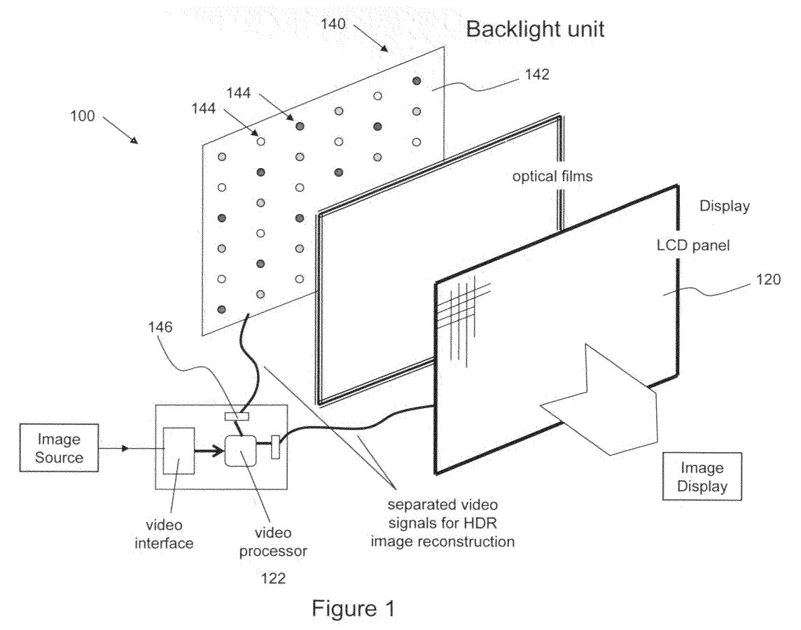

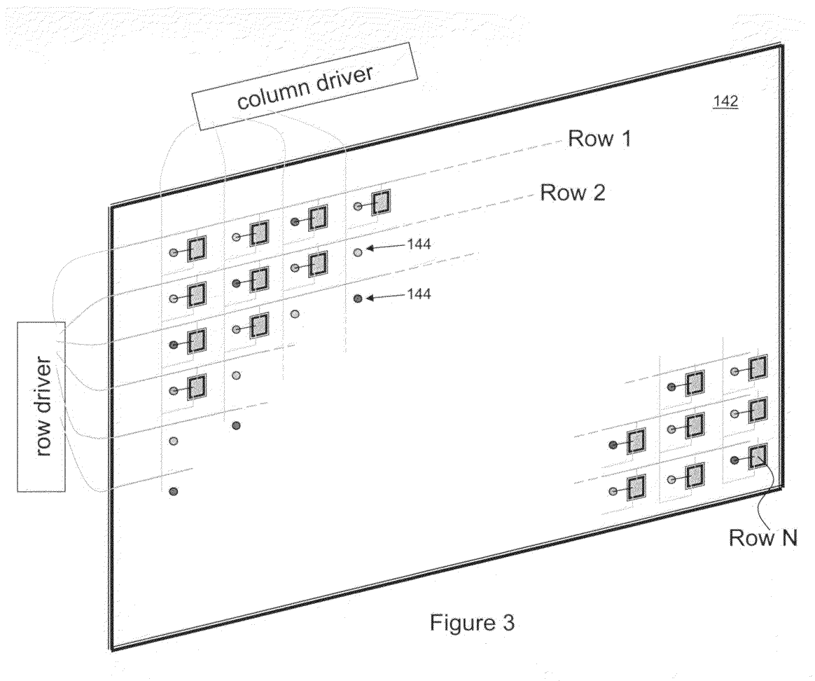

FIGS. 1 and 3 depict an exemplary image display apparatus 100 of an LCD display panel 120 type and a backlight arrangement 140. The LCD display panel is connected to a video processing unit 122 which processes an incoming video image and transforms the image into a form suitable for display on the LCD display panel in cooperation with an LCD timing controller. The video processing unit together with the timing controller operate to cause moving images to be displayed on the image display surface at a predetermined image frame rate (M). Currently, image display apparatus are typically arranged to display images at an image frame rate of M image frames per second, where M is 60 or above. The backlight arrangement comprises a backlight device 142 including a plurality of backlight sources 144 distributedly mounted on a backlight housing and a backlight controller 146.

An LCD display panel comprises a plurality of liquid crystal cells arranged into a matrix of pixels. An image is formed on an LCD display surface by controlling the transparency or opaqueness of individual liquid crystal cells when subject to backlight illumination. By varying the voltage applied to a liquid crystal cell, the “grey” or brightness level of an image pixel can be selected and varied. For a typical or conventional LCD display, a backlight illumination of uniform intensity distribution is applied to all liquid crystal cells on the LCD display. Recent researches and developments show that, by varying the intensity distribution of backlight illumination to follow and commensurate with the intensity distribution of an image to be shown on a display will substantially improve picture quality and contrast.

In order to provide dynamic backlight illumination to an image to appear in an image frame, the intensity distribution of an image to be displayed on the image display surface is first analysed, and the resulting intensity distribution characteristics or profile of the image content of an image frame are calculated to generate a set of backlight illumination data according to a predetermined relationship, for example, according to the algorithm discussed in U.S. Ser. No. 11/707,517. As an example, the backlight arrangement can be arranged so that the intensity of backlight illumination responsible for an image portion is directly commensurate with the image intensity of that image portion so that a brighter image is subject to a brighter backlight illumination and vice versa.

Having obtained a set of backlight illumination data which contains information on the required intensity distribution of backlight on the image frame to be displayed on the image display surface, the data are then processed by the backlight controller 146 to provide desirable backlight illumination.

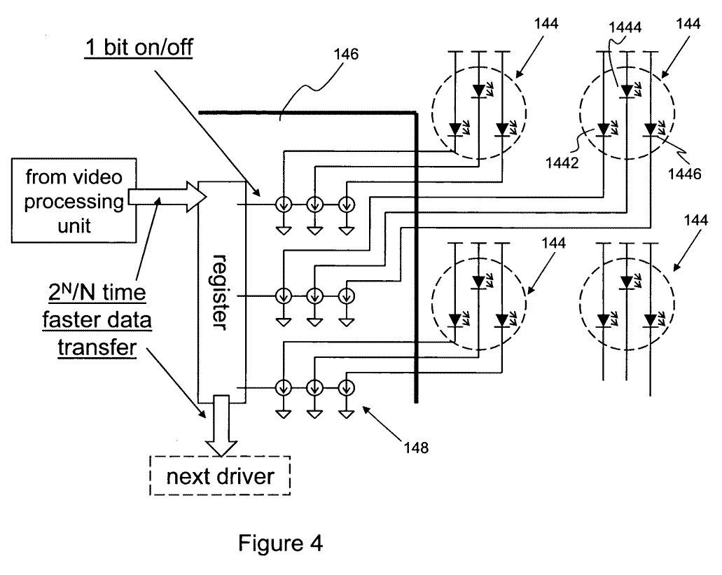

To provide backlight illumination to an LCD display panel 120 which comprises a plurality of liquid crystal pixels arranged into a matrix, the backlight arrangement comprises a plurality of backlight sources 144 also arranged into a matrix such that each backlight source is arranged to provide back illumination to a single LCD pixel, or to a plurality of LCD pixels which collectively defines a specific image portion on the LCD image display surface. In general, backlight sources are arranged so that the totality of backlight sources provides back illumination to the entirety of the LCD display surface. As shown in FIG. 3, the matrix of backlight sources is arranged into a plurality of rows and columns which collectively forms a rectangular matrix. Each backlight source 144 is driven by a driver circuit which is typically, but not essentially, controlled by a current source to supply operating current to the source. The brightness or intensity of a backlight source is typically controlled by varying the current supply to the backlight source. In general, a higher current supply will result in a brighter illumination, while a lower current will result in a reduced level of backlight illumination. Currently, LEDs (light emitting diodes) are commonly used as backlight sources. As shown in FIG. 4, each backlight source comprises a plurality of LEDs, for example, LEDs of different colours, such as red (1442), green (1444) and blue (1446) LEDs. Each of the LED is connected to a respective controllable current source 148 to vary the individual luminous intensity of the individual LEDs, and therefore to provide a selected intensity level of back illumination. By adjusting the relative intensity of the R (1442) G (1444) B (1446) LEDs, white or coloured back illumination can be obtained.

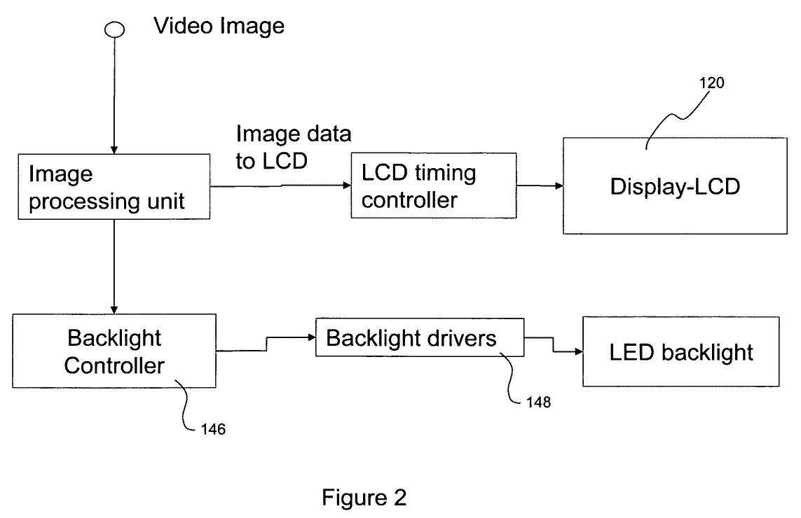

To provide backlight illumination to the LCD display with an appropriate or predetermined intensity distribution across the image display surface, the backlight arrangement of FIGS. 1-4 comprises a backlight controller which receives information from a video image processes 122 on the distribution of image intensity of the image content of an image frame to be displayed on the LCD display surface. The intensity distribution of an image frame is then analysed according to a selected backlight generation algorithm to provide a profile of requisite illumination intensity distribution across the backlight device comprising the plurality of backlight sources. Upon an analysis by the backlight controller of the image intensity distribution, and therefore the requisite backlight illumination intensity distribution, the intensity level of each backlight source for a specific image frame can be determined. The backlight controller comprises an analogue to digital converter (ADC) which is configured to determine which one of a plurality (2^{N}) of intensity levels corresponding to a required intensity of the backlight illumination is to be generated by a backlight source. For example, there could be 2^{N} intensity or grey levels for a backlight source of an N-bit system. As a convenient example, 256 grey levels by way of 256 consecutive backlight illumination frames can be generated for a 8-bit system. For this configuration, the ADC is a 8-bit data converter which converts a requisite intensity level into a 8-bit data which corresponding to one of the 256 levels. Although a 8-bit data conversion system is discussed here, it will be appreciated that other number of bits could be used to provide a higher or lower number of quantisation levels for the required backlight intensity.

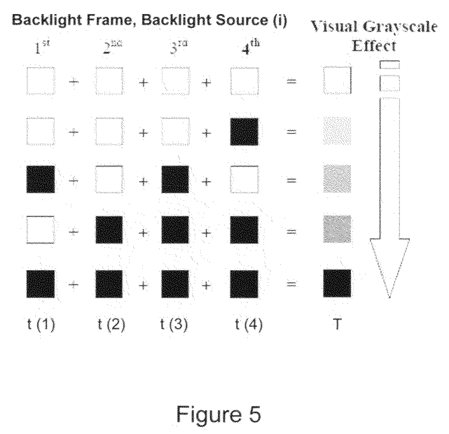

The N-bit intensity data generated by the ADC is then utilized to generate backlight illumination as described below with reference to FIGS. 5 to 8. In order to minimize the amount of data processing and to increase response speed of backlight generation, the N-bit data obtained by conversion of the required backlight intensity level is directly and readily utilized to generate a plurality of backlight illumination frames (or sub-frames) for a single image frame.

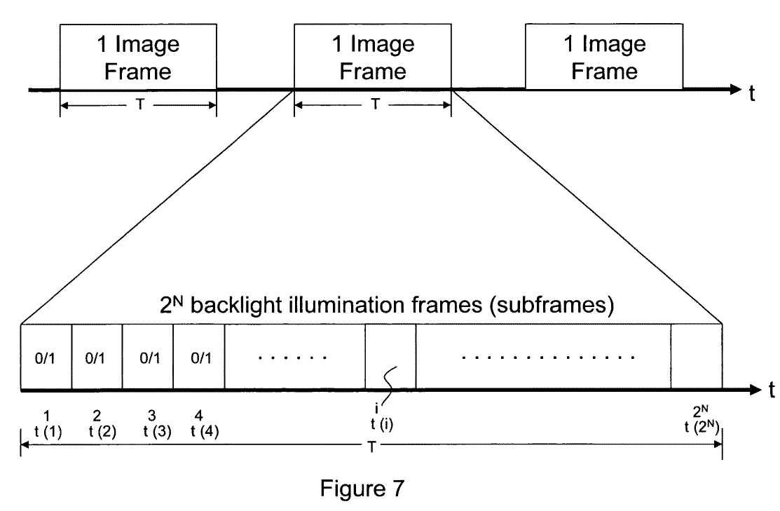

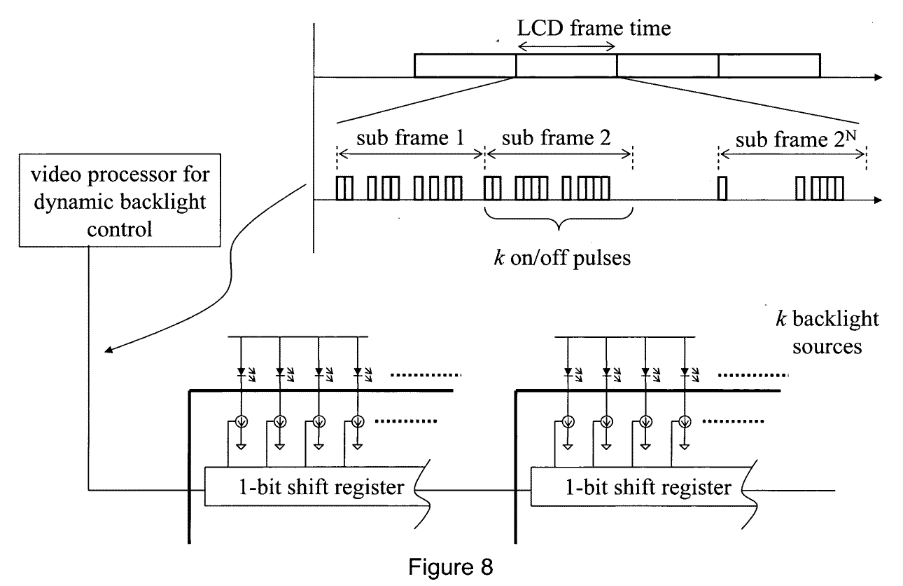

In general, it will be appreciated that a moving image in fact comprises a train of image frames which is displayed consecutively on an image display surface. Typically, the image frames appear at a rate of 60 frames per second or more so that a viewer will perceive the train of image frames as a continuous moving picture, rather than a series of discrete flickering images. Each image frame will have an image frame duration time T which is equal to the inverse of image frame rate (T=1/Ms). As an exemplary implementation of a backlight illumination scheme of this invention, the backlight controller is arranged to generate a plurality (2^{N}) of backlight illumination frames during the duration of an image time frame T for that image frame, as illustrated in FIGS. 7 and 8.

FIG. 5 shows a convenient and simplified example illustrating principles of operation of the backlight illumination scheme of this invention. In FIG. 5, the column of square boxes on the right side of the equations represents a plurality (5 in this example) of requisite grey levels required to be produced by a backlight source during different sub-frame intervals corresponding to a plurality of selected image frames. The square boxes on each row on the left hand side of the equations represent the intensity levels of a backlight source at different backlight illumination frames or sub-frames. In this example, a backlight source is arranged to operate in one of two states, that is, either “ON” or “OFF”, corresponding to an operating logic of either “1” or “0”. An empty box on the left side of the equation represents a light source which is fully on during that sub-frame while a filled square box means an unlit or dark LED. The requisite backlight illumination levels shown on the right hand side of the equations follow an increasing trend of darkness, or a decreasing trend of brightness, along the direction of the arrow.

As shown on the right hand side of the equation, there are a plurality (5 in this case) of discrete levels of backlight illumination level produced by the totality of the 4 backlight illumination frames. In the first row of FIG. 5, the backlight source is turned on at all the 5 backlight illumination frames and the resulting backlight illumination has the highest brightness effect. On the other hand, on the lowest row of FIG. 5, the backlight source is turned “OFF” at all the 5 backlight illumination frames and the resulting backlight illumination is darkest, corresponding to a black (or almost black) background. For the rows intermediate the top and bottom rows, the backlight source is arranged to turn on once, twice and thrice during the 4 backlight illumination frames to produce a gradual, but discrete, levels of increasing grey level or decreasing brightness level. It will be appreciated that the aggregate of backlight illumination perceived by a viewer during the 4 sub-frames (t(1), t(2), t(3) and t(4)), which is completely generated within the duration of an image frame, is visually equivalent to the requisite grey or intensity levels shown on right side of the equation.

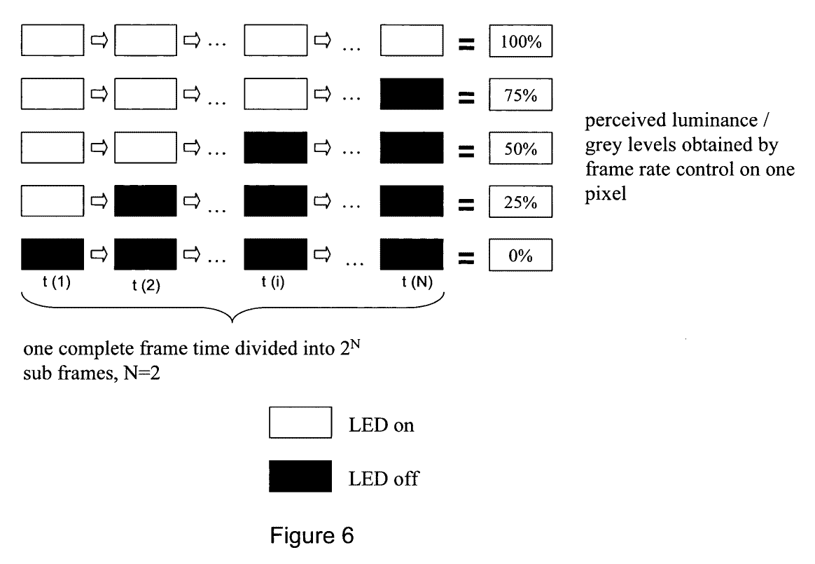

FIG. 6 shows a more generalized illustration of the principle of operation of this invention using the same convention of FIG. 5, while illustrating the operation conditions of a backlight source during a plurality (2^{N} and for this example) of backlight illumination frames during the duration of a single image picture frame. The column of boxes on the right hand side of the equation illustrates the perceived luminance or grey levels in percentage as a convenient quantitative representation.

FIG. 7 illustrates in time domain the timing relationship between the 2^{N} backlight illumination frames in relation to a single image frame having a duration of T. It will be appreciated that a plurality (2^{N} in this case) of backlight illumination frames are generated during the duration of a single picture frame so that each backlight illumination frame of each backlight source has a maximum duration of T/(2N). By turning each backlight source “ON” or “OFF” during a backlight illumination frame, 2^{N} levels of backlight illumination intensity can be obtained by the principles illustrated above as generalized with reference to FIGS. 5 and 6. As illustrated in FIG. 7, each backlight source can be fully turned “ON” for the entire duration of a backlight illumination frame or can be turned “ON” during a portion of duration of the backlight illumination frame.

Referring to FIG. 8, light devices comprise a plurality (K) of backlight sources. Each backlight source is turned on for a fraction (1/K) of the duration of a sub-frame (T/2^{N}) so that the K LED backlight sources are turned ON or OFF during a fraction (1/K) of the sub-frame duration and consecutively. In this example, each backlight source is turned on for a duration of (T/K2^{N}) during each sub-frame.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to an LCD display, it should be appreciated that the invention can apply, whether with or without modification, to other backlit display without loss of generality.

1. An LCD display apparatus arranged to display image on an image display surface at an image frame rate of M image frames per second, the apparatus including a backlight arrangement comprising a LED backlight device for providing backlight illumination to said image display surface and a backlight controller for controlling the generation of backlight and intensity distribution of backlight illumination on said image display surface; wherein the backlight controller comprises a processor configured:
to generate a set of backlight illumination data with reference to the intensity distribution characteristics of the image content of said image frame according to a predetermined relationship, wherein said set of backlight illumination data contains information on the required intensity distribution of backlight on said image display surface for said image frame; and
to generate a plurality of backlight illumination frames for each said image frame during the duration of said image frame based on said set of backlight illumination data; wherein the intensity aggregate of said plurality of backlight illumination frames generated during the duration of said image frame is equivalent to the required intensity distribution of backlight on said image display surface for said image frame.

2. A display apparatus according to claim 1, wherein said image frame rate is set at 60 frames or above per second, and 2ⁿ frames of backlight illumination are generated per image frame, and n is an integer.

3. A display apparatus according to claim 2, wherein n is 8 or more.

4. A display apparatus according to claim 1, wherein said backlight device comprises a plurality of individually controllable backlight sources, each said backlight source being arranged to provide backlight illumination to a pre-determined portion of said image display surface, and said plurality of individually controllable backlight sources being arranged to collectively provide backlight illumination to the entirety of said image display surface;
and wherein said backlight controller is configured to individually adjust the intensity of each said backlight source according to the intensity characteristics of the portion of image to be displayed on the portion of said image display surface under back-illumination by said backlight source.

5. A display apparatus according to claim 4, wherein each individually controllable backlight device comprises an ensemble of LEDs of different colours.

6. A display apparatus according to claim 4, wherein said processor is further configured so that the duration and intensity of backlight illumination generated by each on-cycle of said backlight source is equal.

7. A display apparatus according to claim 6, wherein the sum of total duration of the on-cycles of the plurality of backlight illumination frames of a backlight source for an image frame is equal to the pulse width of a single pulse required to achieve the same backlight intensity.

8. A display apparatus according to claim 1, wherein said processor comprises an analogue-to-digital converter for converting image intensity information into a backlight intensity data comprising on- and off-pulses.

9. A display apparatus according to claim 8, wherein on- and off-pulses are respectively for turning on and turning off a said backlight source, adjacent on-pulses of a said backlight intensity data being separated by at least one off pulse.

10. A display apparatus according to claim 1, wherein the image display surface comprises a liquid crystal layer and said backlight device comprises a plurality of light emitting diodes arranged into a matrix.

11. A method of generating LED backlight illumination for an image display surface of an LCD display device, wherein said LCD display device is arranged to generate video images at an image frame rate of M image frames per second, and the backlight illumination has a pattern of intensity having a distribution of intensity correlating to the intensity distribution of an image frame to be or being display on said display surface, the method comprising the steps of:
evaluating intensity distribution characteristics of said image frame on said image display surface,
determining a pattern of required backlight intensity distribution in relation to said intensity distribution characteristics of said image frame according to a predetermined relationship, and
generating a plurality of frames of backlight illumination for each said image frame, wherein the intensity aggregate of said plurality of frames of backlight illumination generated during the during of said image frame is equivalent to said pattern of required backlight intensity distribution.

12. A method according to claim 11, wherein said image frame rate is at 60 or above per second, and 2ⁿ frames of backlight illumination are generated per image frame, and n is an integer.

13. A method according to claim 12, wherein n is 8 or more.

14. A method according to claim 13, wherein the image display surface is back-illuminated by a plurality of individually controllable backlight sources, each said backlight source being arranged to provide backlight illumination to a pre-determined portion of said image display surface and said plurality of individually controllable backlight sources being arranged to collectively provide backlight illumination to the entirety of said image display surface;
the method comprising the step of individually adjusting the intensity of each said backlight source according to the intensity characteristics of an image to be displayed on the portion of said image display surface being back-illuminated by said backlight source.

15. A method according to claim 14, wherein said plurality of frames of backlight illumination comprises either on- or off-cycles of said backlight source, and the duration and intensity of backlight illumination generated during each on-cycle of said backlight source is equal.

16. A method according to claim 15, wherein adjacent on-cycles of frames of backlight illumination are separated by at least one off-cycle.

17. A method according to claim 11, wherein the image display surface comprises a liquid crystal layer and said backlight device comprises a plurality of light emitting diodes arranged in a matrix.
